(19) United States
(12) Patent Application Publication
(10) Pub. No.: US 2026/0112817 A1
(43) Pub. Date: Apr. 23, 2026

(54) GRAPHENE-BASED RECTIFYING ANTENNA

(71) Applicant: COMMISSARIAT A L'ENERGIE ATOMIQUE ET AUX ENERGIES ALTERNATIVES, Paris (FR)

(72) Inventor: Abdelkader ALIANE, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/359,790

(22) Filed: Oct. 16, 2025

(30) Foreign Application Priority Data
Oct. 18, 2024 (FR) FR2411372

(51) Int. Cl. H01Q 17/00; H01Q 1/38

(52) U.S. Cl. CPC H01Q 17/007; H01Q 1/38

(57) ABSTRACT

The invention relates to a rectifying antenna, comprising: an antenna; and a diode of the Metal-Insulator-Graphene (MIG) type, electrically coupled to the antenna, comprising a metal portion and a conductive portion made of graphene, between which at least one insulating portion is located. The metal portion, the insulating portion(s) and the conductive graphene portion form a vertical stack of thin layer portions. In addition, the antenna is formed of a continuous thin graphene layer, part of which forms the conductive graphene portion of the diode.

### TECHNICAL FIELD

The field of the invention relates to electromagnetic radiation detectors of the rectenna type with a graphene-based diode, in other words rectifying antennas, comprising an electromagnetic radiation-absorbing antenna coupled to a MIG (metal-insulator-graphene) type diode. The invention can be applied in particular to the fields of infrared or terahertz imaging, thermography, gas detection, as well as energy conversion.

### PRIOR ART

Infrared and terahertz detectors that operate at room temperature may consist, for example, of bolometer-type thermal detectors. They may then comprise an absorbing membrane, suspended above a substrate containing a readout circuit, which contains a thermistor material whose electrical resistance varies according to its heating. However, the performance of these thermal detectors is generally limited by their thermal time constant, which may be on the order of ten milliseconds.

Infrared and terahertz detectors can also be rectifying devices comprising a detection antenna coupled to a diode, also known as “rectifying antennas” or “rectennas”, where the diode may be of the MIM (metal-insulator-metal) or MIIM (metal-insulator-insulator-metal) type. These rectennas may have a response time much quicker than that of bolometer-type thermal detectors, to the extent that the transit time of electrons by quantum tunneling, throughout the insulating thin layer of the diode, is on the order of femtoseconds to nanoseconds.

FIG. 1A illustrates the schematic diagram of a rectenna A1, herein in the case of an energy conversion application. It is formed by an antenna A10 adapted to absorb incident electromagnetic radiation, and a rectifier element A20 such as a diode, in this case a MIM-type diode, electrically coupled to the antenna A10. In general, a DC filter A2 is connected in parallel to the diode A20 so as to keep only the continuous component of the rectified AC signal. The operating principle of such a rectenna A1 is as follows: the antenna A10 absorbs the incident electromagnetic radiation and converts it into a high-frequency electrical signal, which is transferred to the input of the diode A20. The diode A20 rectifies the AC electrical signal, and then the DC filter A2 keeps only the continuous component of the rectified electrical signal, to supply it herein to an electrical load A3.

FIG. 1B illustrates an example of an energy band diagram of a MIM diode rectenna, herein in the case of an optical detection application. Such a rectenna is described in particular in the article by de Grover & Moddel titled Applicability of Metal/Insulator/Metal (MIM) Diodes to Solar Rectennas, IEEE Journal of Photovoltaics, Vol. 1, no. 1, pp. 78-83, 2011. The MIM diode comprises two metal layers (metals M1 and M2) between which an insulating layer (electrical insulator I) is disposed. In particular, the diagram depends on the values of the work functions Ψ_{M1} and Ψ_{M2} of the metals M1 and M2, of the electron affinity φ₁, of the insulator I, and of the bias voltage V_{D} applied to the MIM diode. Electrons can pass through the energy barrier according to different conduction mechanisms, for example by Fowler-Nordheim type quantum tunneling or by direct quantum tunneling, depending in particular on the heights φ_{L} and φ_{R} of the energy barriers. These different types of conduction mechanisms are described in particular in the article by Chiu titled A Review on Conduction Mechanisms in Dielectric Films, Advances in Materials Science and Engineering, vol. 2014, Article ID 578168, 18 pages, 2014. In this example, the conduction by quantum tunneling is of the Fowler-Nordheim type.

As indicated in the article by Grover & Moddel 2011, in terms of performance, the aim is for the MIM diode to exhibit a high β responsivity, corresponding to a measurement of the rectified DC signal as a function of the incident power. It can be determined from the I(V) characteristic of the diode using the relationship: β=I″/(2I′), where I′ and I″ are the first and second derivatives of the electric current as a function of the electrical voltage I(V), at the bias voltage V_{D}. In addition, the diode should have a low dynamic resistance to achieve good impedance matching with the antenna.

However, it appears that, for a MIM diode, i.e. a diode with one single insulating layer located between the two metal layers, the optimization of the responsivity leads to a degradation of the value of the dynamic resistance, and vice versa. Also, it does not seem possible to optimize both the responsivity and the dynamic resistance of a MIM diode. Yet, it seems that a MIIM diode, i.e. a diode with two insulating layers having different electron affinities, makes it possible to overcome this constraint, so that the MIIM diode can be configured to exhibit both high responsivity and low dynamic resistance. This is the case in particular when the MIIM diode enables conduction of charge carriers by resonant quantum tunneling.

In this respect, FIG. 1C illustrates an example of an energy band diagram of an infrared rectenna with a MIIM diode configured to enable conduction of charge carriers, herein electrons, by resonant quantum tunneling. This type of energy band diagram is described in particular in the article by Grover & Moddel titled Engineering the current-voltage characteristics of metal-insulator-metal diodes using double-insulator tunnel barriers, Solid-State Electron. 67, 94-99 (2012), as well as in that by Belkadi et al. titled Demonstration of resonant tunneling effects in metal-double-insulator-metal (MI²M) diodes, Nat Commun 12, 2925 (2021).

The resonant quantum tunneling is present when the electrons pass through the insulating layers throughout a quantum well in the form of a rectangular triangle located between the two insulating layers. Electrons whose energy corresponds to the energy levels of the almost-bound states of the quantum well can pass through the insulating layers and reach the metal layer M2 while minimizing reflection, thereby producing a higher electric current than in the case of a non-resonant quantum tunneling. It should be noted that, in this example, the electrons pass through the first insulating layer by Fowler-Nordheim type quantum tunneling, and the second insulating layer by direct quantum tunneling. The authors have demonstrated that by using insulators with different electronic affinities, it is possible to configure a resonant tunneling MIIM-type diode to achieve both high responsivity and low dynamic resistance, which cannot be achieved with an MIM diode.

Furthermore, the document by Hemmetter et al. entitled Terahertz Rectennas on Flexible Substrates Based on One-Dimensional Metal-Insulator-Graphene Diodes, ACS Appl. Electron. Mater. 2021, 3, 3747-3753, describes a THz rectenna comprising an aluminum bow-tie antenna electrically coupled to a MIG-type diode with a junction referred to as “1D”.

In this rectenna, the MIG-type diode is not formed by a vertical stack of thin layers, but is structured in the plane of the substrate, where two metal portions (one made of Ti and the other of Ni) are located on either side of a mesa in which a thin layer of graphene is buried. A thin insulating layer of TiO₂ extends along one side of the mesa, and is in contact with one end of the thin graphene layer and the titanium metal portion. Thus, nickel and graphene form the cathode of the diode and titanium forms the anode. The two parts of the bow-tie antenna extend above the MIG diode and come into contact with the two metal portions.

However, there is a need to improve certain aspects of a MIM-type diode rectenna, either for infrared or terahertz detection applications or energy conversion applications.

### DISCLOSURE OF THE INVENTION

The invention aims to remedy, at least in part, some of the drawbacks of the prior art, and more particularly to provide a MIG-type diode rectenna with improved performance.

For this purpose, the object of the invention is a rectifying antenna for detecting electromagnetic radiation, comprising: an antenna adapted to absorb electromagnetic radiation; and a Metal-Insulator-Graphene (MIG)-type diode, electrically coupled to the antenna, comprising a metal portion and a conductive graphene portion, between which at least one insulating portion is located.

According to the invention, the metal portion, the insulating portion(s) and the conductive graphene portion form a vertical stack of thin layer portions. In addition, the antenna is formed by a continuous thin layer of graphene, part of which forms the conductive graphene portion of the diode.

Some preferred but non-limiting aspects of this rectifying antenna are as follows.

The thickness of the antenna, and therefore of the conductive graphene portion, may be between 1 and 10 monolayers.

The antenna may have a square or rectangular shape.

The conductive graphene portion may be located above the insulating portion(s) and the metal portion.

The rectifying antenna may comprise a reflective layer, covered by an intermediate insulating layer on which the antenna rests, forming a quarter-wave cavity with respect to the electromagnetic radiation to be absorbed.

The rectifying antenna may comprise connection pads for biasing the diode, a first connection pad being located below and in contact with the metal portion, and a second connection pad being located below and in contact with the antenna.

The insulating portion(s) may be made of Al₂O₃, ZrO₂, HfO₂, ZnO, SiO₂, or HfAlO.

The insulating portion(s) may have a thickness of between 0.5 and 4 nm.

The diode may have dimensions of between 20×20 nm and 100×100 nm.

The rectifying antenna may comprise an electrical source adapted to apply a non-zero bias voltage V_{D} to the diode.

The antenna may be adapted to absorb infrared or terahertz electromagnetic radiation.

The invention also relates to an optoelectronic device comprising an array of rectifying antennas according to any of the preceding features, which are identical to one another.

The invention also relates to a method for manufacturing a rectifying antenna according to any of the preceding features, comprising the following steps:
making the metal portion of the diode;
making at least one insulating portion, on and in contact with the metal portion;
making a graphene layer extending over and in contact with the insulating portion;
localized etching of the graphene layer, thereby forming the antenna, of which the part located in contact with the insulating portion forms the conductive graphene portion.

The manufacturing method may comprise the following steps:
making a first and a second connection pad in an intermediate insulating layer;
the metal portion rests on and is in contact with the first connection pad, and the second connection pad is flush with the intermediate insulating layer;
the graphene layer is made so as to be over and in contact with the insulating portion, and to extend over the intermediate insulating layer to come into contact with the second connection pad.

### BRIEF DESCRIPTION OF THE DRAWINGS

Other aspects, aims, advantages and characteristics of the invention will become apparent upon reading the following detailed description of preferred embodiments thereof, provided as a non-limiting example, and made with reference to the accompanying drawings wherein:

FIG. 1A, already described, is a schematic view of a diode rectifying antenna coupled to an antenna, according to an example from the prior art;

FIG. 1B, already described, illustrates an example of an energy band diagram of a MIM diode rectifying antenna, according to an example from the prior art;

FIG. 1C, already described, illustrates an example of an energy band diagram of a MIIM diode rectifying antenna, according to an example from the prior art;

FIG. 2A and FIG. 2B are schematic and partial views, in perspective (FIG. 2A) and in cross-section (FIG. 2B) of a graphene-based rectifying antenna according to one embodiment.

FIG. 3 illustrates a change in the absorption rate of the antenna of a rectenna according to one embodiment;

FIGS. 4A to 4J illustrate different steps of a method for manufacturing a graphene-based rectifying antenna according to one embodiment.

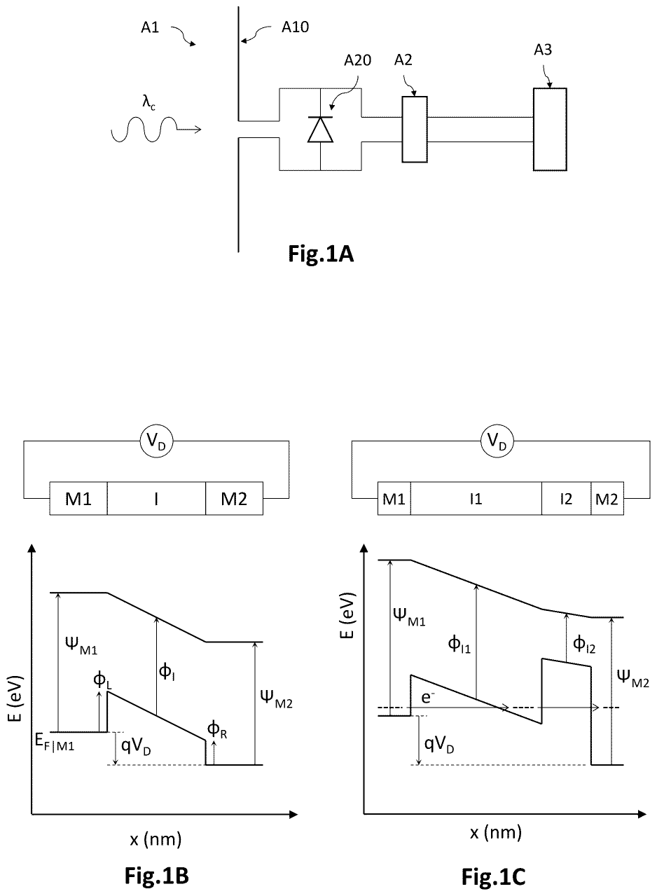

### DETAILED DISCLOSURE OF SPECIFIC EMBODIMENTS

In the Figures and in the following description, the same references represent identical or similar elements. Furthermore, the different elements are not represented to scale so as to improve the clarity of the Figures. Moreover, the different embodiments and alternatives are not mutually exclusive and could be combined together. Unless stated otherwise, the terms “substantially”, “about”, and “in the order of” mean to within 10%, and preferably to within 5%. Moreover, the terms “between . . . and . . . ” and equivalents mean that the bounds are included, unless specified otherwise.

The invention relates to a graphene-based rectenna-type electromagnetic radiation detector, in other words a rectifying antenna comprising a graphene antenna adapted to absorb electromagnetic radiation coupled to a MIG-type diode. In the remainder of the description, such a rectifying antenna is referred to as “rectenna”. It can be used as an infrared or terahertz detector, or even as an energy converter, in particular depending on whether or not the diode is biased at a non-zero voltage V_{D}.

In general, the antenna of the rectenna may be adapted to absorb an electromagnetic radiation of interest in a spectral range in particular from the infrared to the terahertz. Thus, the antenna may be configured to absorb in the near-infrared (SWIR, standing for Short Wavelength IR, in English) corresponding to a spectral range from about 0.8 to 2.7 μm; in the middle infrared (MWIR, standing for Middle Wavelength IR, in English) corresponding to a spectral range from about 3 to 5 μm; in the long infrared (LWIR, standing for Long Wavelength IR, in English) corresponding to a spectral range from about 7 to 14 μm; or in the terahertz whose spectral range extends from about 0.1 to 1 mm (about 0.3 to 3 THz).

According to the invention, the rectenna comprises a thin conductive graphene layer that extends continuously and forms both the antenna and the conductive graphene portion of the diode. This is a vertical MIG-type diode insofar as it is formed from a vertical stack of thin layer portions, namely a metal portion, at least one insulating portion, and the conductive graphene portion.

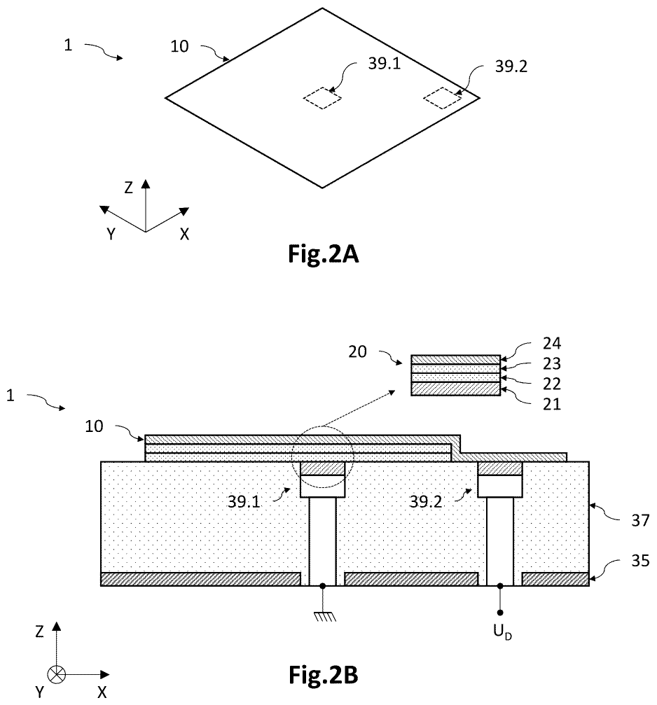

FIGS. 2A and 2B are schematic and partial views, in perspective (FIG. 2A) and in cross-section (FIG. 2B), of a rectenna 1 according to one embodiment.

Here and throughout the remainder of the description, we define a direct three-dimensional XYZ coordinate system, where the XY plane is parallel to the main plane of antenna 10 of rectenna 1, and where the Z axis is oriented along the thickness of MIG-type diode 20 of the rectenna 1. Moreover, the terms “lower” and “upper” should be understood relative to an increasing positioning according to the +Z direction.

In this example, the rectenna 1 is an infrared detector whose antenna is adapted to absorb MWIR and/or LWIR infrared radiation. Of course, the rectenna 1 may be configured to absorb other spectral ranges of infrared, even in the terahertz range.

Preferably, the described rectenna 1 belongs to an array of unit rectennas, that are identical to one another, connected to a control and readout electrical circuit (ROIC) in charge of biasing the diodes 20 and reading the generated electrical signals.

In general, the rectenna 1 comprises an antenna 10, the MIG-type diode 20 and a DC filter (not shown). Here it comprises an electrical source (not shown) to bias the MIG-type diode at a non-zero voltage V_{D} (application in optical detection). However, in the case of an energy conversion application (e.g. solar cell), the MIG-type diode may be unbiased or biased at zero voltage, and may be connected to an electrical load.

The antenna 10 is adapted to absorb incident electromagnetic radiation, here LWIR infrared radiation and is electrically connected to the MIG-type diode 20 to transmit thereto the electrical signal generated in response to the absorption of the infrared radiation of interest.

The antenna 10 is formed by a thin conductive layer made of graphene, with a thickness of between 1 and 10 monolayers, for example, preferably between 1 and 5 monolayers, and preferably between 1 and 3 monolayers. A monolayer of graphene has a thickness of approximately 0.34 nm. The graphene is n-doped so that the antenna 10 has a resistance per square that is substantially equal to the impedance of the vacuum, within 10% or even within 5%, thus optimizing the absorption of the radiation to be detected. As the impedance of the vacuum is approximately 377Ω, the antenna 10, which is formed of a doped graphene monolayer, can have a resistance per square of about 360 Ω/sq. The n-type doped graphene is obtained by doping with N₂ or NH₃, and may have a doping level of between 1 at. % and 10 at. % with NH₃ doping for example.

The antenna 10 extends continuously over a thick insulating layer 37, and in a substantially planar manner (possibly by means of the thickness of the insulating layer(s) 22, 23 of the MIG-type diode 20). It is therefore located entirely on the same side of the MIG-type diode 20, in this case above it.

The antenna 10 is a patch antenna, insofar as it is formed of a conductive layer (in this case graphene) and rests on a thick insulating layer. In this example, a reflective layer 35 is located under the antenna 10 and forms a resonant optical cavity with it. The antenna 10 may have all kinds of shapes, for example rectangular or square, circular, triangular, elliptical, etc. It can also be spiral-shaped, serpentine or bow-tie-shaped. In this example, the antenna 10 is advantageously rectangular or square, so as to be virtually insensitive to the polarization of the incident light.

The antenna 10 may have a width W

$$W = \frac{{λ}_{0}}{2} \sqrt{\frac{2}{{ε}_{r} + 1}}$$

where λ₀ the resonance wavelength associated with the optical cavity, and where εᵣ is the dielectric constant of the insulating thickness layer 37 that fills the optical cavity. An effective dielectric constant ε_{r,eff} can be defined

$${ε}_{r , eff} = \frac{+ 1}{2} + \frac{{ε}_{r} - 1}{2} \times {( 1 + \frac{12 h}{W} )}^{- 0.5} ,$$

where h is the height of the optical cavity (vertical distance between the antenna and the reflective layer). Finally, the antenna 10 can have a length L defined by the following relationship:

$$L = \frac{{λ}_{0}}{2 \sqrt{{ε}_{r , eff}}} - h \times 0.824 \frac{( {ε}_{r , eff} + 0.3 ) ( W / h + 0.264 )}{( {ε}_{r , eff} - 0.258 ) ( W / h + 0.8 )} .$$

The MIG-type diode 20 is adapted to receive the high-frequency AC electrical signal generated by the antenna 10 in response to the absorption of the electromagnetic radiation of interest, here in the MWIR and/or LWIR, and to rectify it to provide a rectified AC electrical signal.

The diode 20 is formed by a vertical stack of thin layer portions, namely a metal portion 21, at least one insulating portion 22, 23, and the conductive portion 24 made of graphene, which is part of the continuous thin graphene layer that forms the antenna 10. In this example, the diode 20 comprises two separate insulating portions 22, 23.

Moreover, the conductive graphene portion 24 (and therefore the antenna) is located above the insulating portions 22, 23 and the metal portion 21. Also, in this example, the diode 20 comprises, arranged in the +Z direction: the lower metal portion 21, a first insulating portion 22 which extends over and in contact with the lower metal portion 21, a second insulating portion 23 which extends over and in contact with the first insulating portion 22, and finally the upper conductive portion 24 made of graphene.

It should be noted that, in the diode 20, each of the portions 21, 22, 23, 24 extends continuously parallel to the plane XY, and is in continuous contact with the neighboring portion(s) over its entire surface. A distinction is thus made from the case where a lower portion would be formed by distinct lines or grooves, such that the adjacent upper portion would not be in contact, over its entire surface, with the grooved lower portion.

The conductive upper portion 24 is therefore made of graphene, and is a part of the continuous thin layer that forms the antenna 10. There is therefore no discontinuity or separation between the antenna 10 and the conductive portion 24. The conductive portion 24 therefore has the same thickness as that of the antenna 10. In this example, the thickness is equal to a monolayer, i.e. about 0.34 nm. The work function Ψ_{G} of graphene is approximately 4.5 eV.

The lower metal portion 21 is made of at least one metal M whose work function is denoted by Ψ_{M}. This metal may be selected from Ti, TiN, W, Al, Ni, Au, Pt, Cr, AlCu, among others. It may also be graphene (which here, for simplicity, is equated to the metal M)

In this case of an optical detection application, the metal M may be selected to be identical or different from graphene in terms of work function. However, in the case of an energy conversion application, the work functions Ψ_{M1}, Ψ_{M2} are different from one another. Preferably, the work function Ψ_{M} is greater than Ψ_{G}, for example by at least 5% or even at least 10%. Thus, the upper conductive portion 24 can be made of graphene (Ψ_{G}=4.5 eV) and the lower metal portion 21 can be made of Ni (Ψ_{M}=5.15 eV), Au (Ψ_{M}=5.3 eV), or Pt (Ψ_{M}=5.4 eV) approximately.

At least one insulating portion 22, 23 is located between the lower metal portion 21 and the upper conductive graphene portion 24. It extends here over the thick insulating layer 37, over a range which may be limited to the dimensions of the diode 20, or, as here, over a larger range.

In the event that only one insulating portion is present, it is then made of a single electrical insulating material I with electronic affinity φ and dielectric constant εᵣ, and is in contact with the lower metal portion 21 and the upper conductive portion 24 made of graphene. The dielectric constant corresponds to the relative permittivity.

In the case where two insulating portions are present, an insulating portion 23 is located in contact with the upper conductive portion 24 made of graphene, and is made of an electrical insulating material 11 of electronic affinity φ₁ and dielectric constant εᵣ₁. And the insulating portion 22 is located between the insulating portion 23 and the lower metal portion 21, and is made of an electrical insulating material 12 with electronic affinity φ₂ and dielectric constant εᵣ₂. Preferably, the insulator 11 and the insulator 12 have a relative electronic affinity difference Δφ/φ₂=|φ₁−φ₂|/φ₂ at least equal to 10%, or even 50%, to 100%, or even more.

The insulating material(s) may be selected from aluminum oxide, hafnium oxide, zirconium oxide, silicon oxide, zinc oxide, copper oxide, nickel oxide, etc., such as Al₂O₃, HfO₂, HfAlO, ZrO₂, ZnO, CuO, NiO, SiO₂. By way of example, the diode 20 may be formed from the stack of the following materials: graphene/ZnO/HfO₂/metal. Other insulator pairs may be used, such as for example Al₂O₃/HfO₂, ZnO/HfO₂, ZnO/Al₂O₃, ZnO/HfAlO, among others. Preferably, the insulating materials are selected so that they have a high dielectric constant (high-k material), such as for example Al₂O₃, HfO₂, ZrO₂ and ZnO, so as to increase the asymmetry of the diode 20 and reduce its dynamic resistance.

It should also be noted that the insulating portion(s) 22, 23 preferably have a thickness of between approximately 0.2 and 4 nm, and preferably between 0.5 and 2 nm. The insulating portions 22, 23 may have an identical thickness or different thicknesses.

The insulating portion(s) 22, 23 are thin layer portions, i.e. they have been produced using conventional microelectronics techniques, including chemical deposition (CVD, ALD . . . ), physical deposition (PVD . . . ), among others. In the case of an insulating portion made of a silicon oxide with a thickness of preferably between 0.5 and 2 nm, this is preferably produced by ion beam deposition (IBD) at ambient temperature, so that its interface has no or few defects such as precursors, thus preserving its electronic qualities.

As indicated previously, the antenna 10 rests on a thick insulating layer 37, for example made of a silicon oxide, which spaces it vertically apart from an underlying reflective layer 35, made of a metal for example. This vertical spacing is in the order of λ_{c}/4n, where n is the optical index of the medium separating the antenna 10 from the reflective layer 35. Thus, a quarter-wave cavity is formed which improves the rate of absorption by the antenna 10.

The diode 20 is biased by means of two connection pads 39.1, 39.2 located under the diode 20 and the antenna 10, and which extend vertically into the thick insulating layer 37. One connection pad 39.1 is located under the MIG-type diode 20 and comes into electrical contact with the lower metal portion 21, and another connection pad 39.2 is located under the antenna 10 (and offset in the plane XY relative to the diode 20) and comes into electrical contact with the latter. The connection pad 39.2 may be located near an edge of the antenna 10. Moreover, in this example, the diode 20 is located in the center of the antenna 10, but alternatively, it could be offset therefrom.

Preferably, the diode stack 20 has dimensions in the plane XY of between 20 nm×20 nm and 100 nm×100 nm, for example equal to 50 nm×50 nm. The antenna 10 may have a square shape with the sides being 4.5 μm, and the antennas of the rectennas may be arranged periodically at 5 μm intervals. The antenna 10 and the conductive upper portion 24 made of graphene may have a thickness of a monolayer (0.34 nm), the adjacent insulating portion 23 may be made of HfO₂ with a thickness of 0.5 nm, the following insulating portion 22 may be made of Al₂O₃ with a thickness of 0.5 nm, and the lower metal portion 21 may be made of nickel. The connection pads 39 may be made of metals such as copper, tungsten, among others, and the thick insulating layer 37 may have a thickness of about 1 to 2 μm, depending on whether absorption in MWIR and/or LWIR is desired.

The rectenna 1 also comprises a DC filter (not shown), electrically connected to the diode 20, so as to filter the rectified AC electrical signal so as to keep only the DC continuous component. Afterwards, the filter is electrically connected to a readout circuit of the electrical signal (optical detection application) or to an electrical load (energy conversion application).

The electrical source may be present so as to electrically bias the diode 20 at a bias voltage V_{D}. For example, the lower metal portion 21 is grounded here, while the upper conductive graphene portion 24 is brought to the electrical potential U_{D}, which may be zero or non-zero depending on the intended application. The electrical voltage V_{D} may be between about 0 and 0.3 V. In the case of a MIIM diode (with two different insulators), the bias is positive between 0 and +0.3V, and preferably at a bias of about +0.1 V to achieve maximum responsivity.

It should noted here that the performance of the rectenna 1 depends in particular on the dynamic resistance R_{D} of the diode 20, the asymmetry As_{D} of the I(V) characteristic, and the R responsivity. The dynamic resistance R_{D} may be determined from the relationship R_{D}=1/I′, where I′ is the first derivative of the electric current I as a function of the electrical voltage V, at the bias voltage V_{D}. The asymmetry As_{D} may be determined from the relationship As_{D}=|I_{f}/Iᵣ|, at the bias voltage V_{D}, where I_{f} is the value of the direct electric current and I, is that of the reverse electric current. Finally, the β responsivity has been defined previously and may be determined by the relationship: β=I″/(2I′).

Thus, the rectenna 1 comprises an antenna 10 electrically coupled to a diode 20 of the MIG type, where the same continuous thin graphene layer forms the antenna 10 and the conductive portion 24 of the diode 20. The fact that the antenna 10 is formed of a thin graphene layer allows it to effectively absorb electromagnetic radiation of interest, in particular in the MWIR and LWIR. Furthermore, the fact that the same continuous thin graphene layer forms both the antenna 10 and one of the conductive portions of the diode 20 makes it possible to efficiently transfer to the diode 20 the electrons excited by the light absorbed by the antenna 10.

Furthermore, in the case where the antenna 10 is a rectangular and preferably square patch antenna, it is virtually insensitive to the polarization of the electromagnetic radiation of interest, which improves the broadband absorption.

It should also be noted that the work function of graphene can be modified, and more specifically reduced, by applying a suitable treatment. This may then involve treating more precisely the free surface of the upper conductive graphene portion 24, so as to locally reduce the work function of the graphene and therefore lower the potential barrier between the upper conductive graphene portion 24 and the adjacent insulating portion 23. This then leads to increased responsivity and lower dynamic resistance of the diode 20. Such treatment may be a surface treatment leading to the adsorption of molecules such as NO₂, N₂H₂, NH₃, among others. It can also involve an ultraviolet treatment.

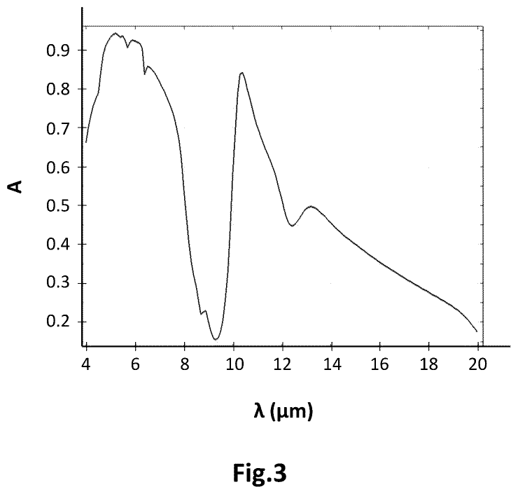

FIG. 3 illustrates an example of the change in the absorption rate A of the graphene antenna 10 as a function of the wavelength of the incident electromagnetic radiation, here in the infrared range comprising MWIR (3-5 μm) and LWIR (8-14 μm).

In this example, a detection device comprising an array of rectennas 1 similar to that of FIG. 2B is considered, where the graphene antennas 10 are arranged periodically at 6 μm intervals. Each antenna 10 is formed of a 0.34 nm thick graphene monolayer, with a side dimension of 5×5 μm, the graphene being n-doped so that the antenna 10 has a resistance per square of around 360 Ω/sq. The antenna 10 rests on a 0.34 nm thick layer 37 of SiO₂, which forms an optical cavity with an underlying reflective layer 35.

The graphene antenna 10 exhibits very good absorption in the MWIR and LWIR bands (in particular in the MWIR band due to the size of the optical cavity). Furthermore, it is possible to adjust the size of the optical cavity so as to optimize the absorption in the LWIR band, while maintaining good absorption in the MWIR band, and minimizing the (already low) parasitic absorption by the SiO₂ of the optical cavity.

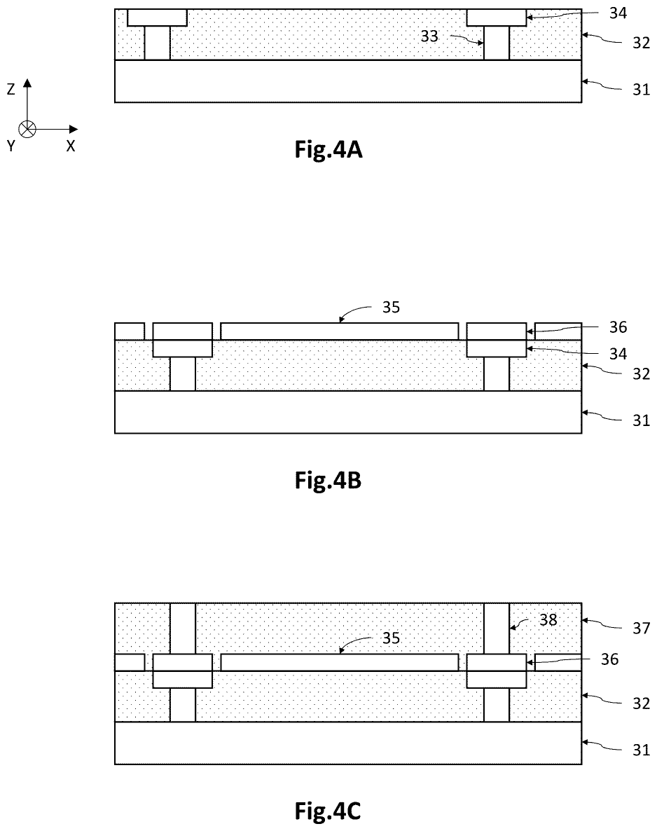

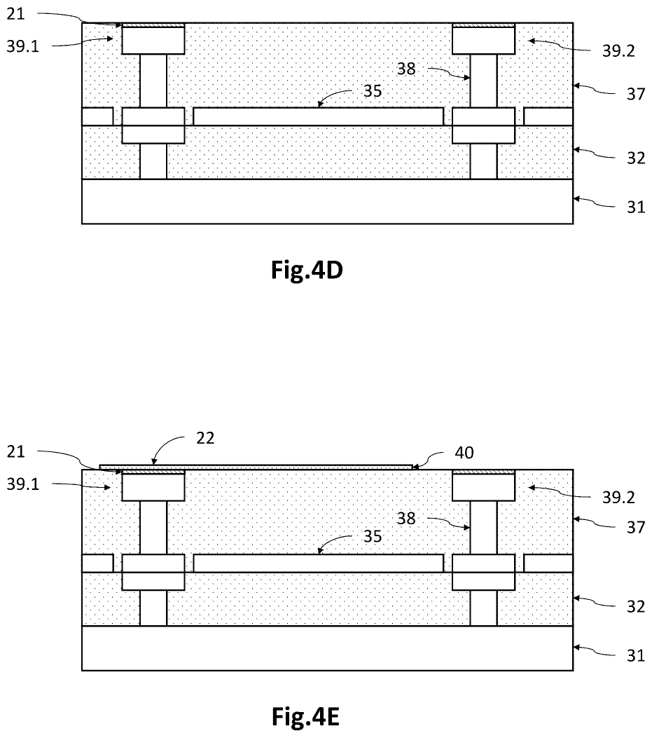

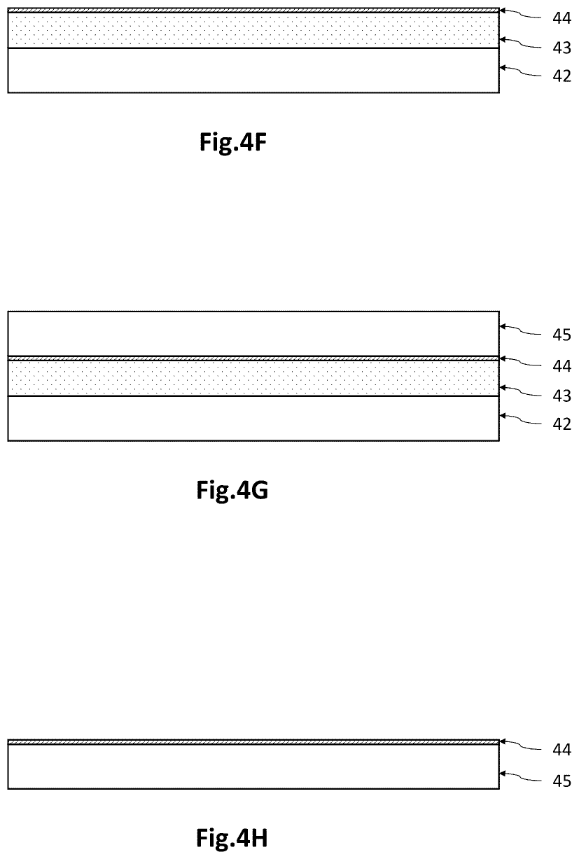

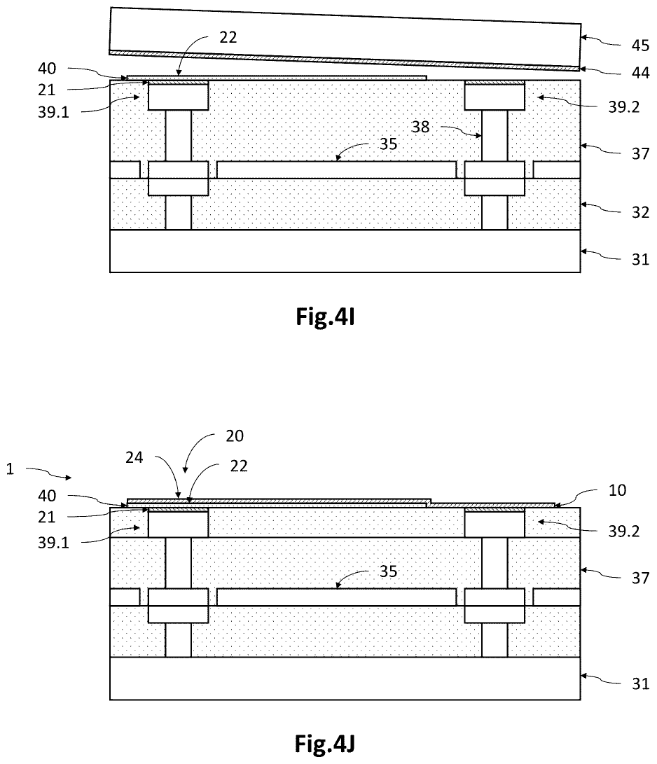

FIGS. 4A to 4J illustrate different steps of a method for manufacturing a rectenna 1 according to one embodiment. The rectenna 1 is adapted here to absorb electromagnetic radiation of interest in the MWIR and LWIR. One single rectenna is shown herein but, preferably, the method relates to the manufacture of an array of identical rectennas on the same readout substrate 31.

With reference to FIG. 4A, a readout substrate 31 is provided, containing a readout and control circuit (ROIC), for example of the CMOS type, adapted here to electrically bias the diode and to read the rectified electrical signal originating from the rectenna in response to the absorption of light radiation.

The readout substrate 31 is covered by a lower insulating layer 32, made of an insulating material such as a silicon oxide. First conductive vias 33 are then made through the lower insulating layer 32, connected to connection pads (not shown) on the readout substrate 31, followed by first electrical connection pads 34 in contact with the conductive vias 33.

Referring to FIG. 4B, the reflector 35 and intermediate connection pads 36 are made afterwards. For this purpose, a layer made of at least one metal material is deposited, which is structured by lithography and localized etching to form the reflector 35 and connection pads 36. The metal layer may be a multilayer, for example of the Ti/TiN/AlCu or Ti/TiN/AlSi type. AlCu or AlSi may have a thickness of at least 80 nm, for example equal to 300 nm. The connection pads 36 are in electrical contact with the connection pads 34.

With reference to FIG. 4C, an intermediate insulating layer 37, made of an insulating material such as a silicon oxide, is deposited so as to then define the quarter-wave cavity with the antenna. SiO₂ can thus be deposited by plasma-enhanced chemical vapour deposition (PECVD) to a thickness of, for example, between 0.3 and 2 μm, for example 1.2 μm, at a deposition temperature of less than or equal to 400° C. in order to comply with the thermal budget of the CMOS readout circuit. A mechanical-chemical polishing step may then be performed to remove excess material and planarize the insulating intermediate layer 37 to a thickness of about 1 μm (the optical cavity has a thickness of λ/4n where n is the refractive index of the medium forming the optical cavity). Afterwards, second conductive vias 38 are made through the intermediate insulating layer 37, in contact with the connection pads 36.

With reference to FIG. 4D, upper connection pads 39 (39.1, 39.2) are then produced as well as the lower metal portion 21 of the diode. For this purpose, a layer made of at least one metal material, structured by lithography and etching, is deposited. Preferably, the layer is formed of a metal multilayer, for example of Ti/AlCu/TiN. This multilayer forms both the connection pads 39.1, 39.2 and the lower metal portion 21 (here in TiN) of the diode. More specifically, the pad 39.1 is covered by the metal portion 21, whereas the pad 39.2 comprises a metal portion (here in TiN). The intermediate layer 21 made of AlCu has a thickness preferably larger than 80 nm to ensure the quality and the continuity of the layer. The connection pad 39.1 is intended to bias the diode, and the connection pad 39.2 is intended to bias the antenna 10. Afterwards, an new insulating layer 40, for example made of a TEOS-type silicon oxide, is deposited, which is planarized to clear the upper face of the metal portion 21 of the diode as well as that of the connection pad 39. In the Figure, the insulating layer that surrounds the vias 38 and the connection pads 39 (and therefore the metal portion 21) in the plane XY is still denoted “37”. Its thickness helps to define the size of the optical cavity.

With reference to FIG. 4E, a first thin insulating layer 40 is then deposited on the free face of the stack, which extends over and in contact with the metal portion 21. This thin insulating layer 40 is etched locally to leave the free face of the connection pad 39.2 exposed. The portion of the thin insulating layer 40 that is on and in contact with the metal portion 21 forms the insulating portion 22. The remainder of the thin insulating layer 40 can extend over the thick insulating layer 37, facing the reflector 35. In this example, the thin insulating layer 40, and therefore the insulating portion 22, is made of Al₂O₃ with a thickness of between 0.5 and 2 nm, and here of 0.5 nm. It may be deposited by atomic layer deposition (ALD) at between about 200° C. and 400° C.

With reference to FIG. 4F, a graphene layer 44, herein a monoatomic layer, is formed over an insulating layer 43, here made of a silicon oxide, resting on a support substrate 42. Graphene may be initially deposited over a copper substrate (not shown) using a high-temperature chemical vapor deposition technique, for example at about 1,000° C., and then transferred onto the oxide layer 43.

With reference to FIG. 4G, a layer 45 of a polymer such as poly(methyl methacrylate) (PMMA), or a layer of adhesive, is deposited over the graphene layer 44. This layer 45 will form a flexible handle for handling the graphene layer 44.

With reference to FIG. 4H, the support substrate 42 and the oxide layer 43 are removed, for example by wet etching the oxide layer 43 with hydrofluoric acid (HF) in vapor phase. Thus, a PMMA layer 45 is obtained on which the graphene layer 44 rests. It should be noted that this technique for making and transferring a graphene layer is described in particular in the article by Lee et al. titled Multilayered Graphene Electrode using One-Step Dry Transfer for Optoelectronics, Current Optics and Photonics, Vol. 1, Issue 1, pp. 7-11 (2017).

With reference to FIG. 4I, the graphene layer 44 is transferred onto the stack, so that it comes into contact with the insulating portion 22 (and more broadly the insulating layer 40), the thick insulating layer 37, and the connection pad 39.2.

With reference to FIG. 4J, the PMMA layer 45 is then removed, for example with an acetone-type solvent, to expose the upper face of the graphene layer 44. The graphene layer is etched locally, so as to form the antenna 10. The part of the antenna 10 which is in contact with the insulating portion 22 forms the upper conductive portion 24 made of graphene.

Thus, a rectenna 1 is obtained consisting of an antenna 10 and a MIG-type diode 20, where a same continuous thin layer forms the antenna 10 and the conductive graphene portion 24 of the diode 20. The diode 20 is biased by means of connection pads 39.1, 39.2, one located under the diode 20, and the other under the antenna 10, and which are connected to the underlying readout circuit by conductive vias. In addition, the antenna 10 is vertically spaced apart from a reflector 35, thereby forming a quarter-wave cavity optimizing the absorption of the light radiation of interest (here MWIR and/or LWIR). Also, not only does the graphene antenna 10 effectively absorb the electromagnetic radiation of interest (in the case where it is a patch antenna not sensitive to the polarization of the light), but the electrons are optimally transferred to the diode 20, since the same continuous thin layer forms the antenna 10 and the conductive portion 24 of the diode 20. The rectenna 1 therefore offer high performance, in terms of antenna absorption, but also diode responsivity and dynamic resistance.

Particular embodiments have just been described. Different alternatives and modifications will become apparent to the person skilled in the art.

1. A rectifying antenna for detecting electromagnetic radiation, comprising:
an antenna, configured to absorb the electromagnetic radiation;
a diode of the Metal-Insulator-Graphene type, electrically coupled to the antenna, comprising a metal portion and a conductive portion made of graphene, between which is disposed at least one insulating portion;
wherein:
the metal portion, the at least one insulating portion and the conductive graphene portion form a vertical stack of thin layer portions;
the antenna is formed of a continuous thin graphene layer, part of which forms the conductive graphene portion of the diode.

2. The rectifying antenna according to claim 1, wherein the thickness of the antenna and therefore of the conductive graphene portion is between 1 and 10 monolayers.

3. The rectifying antenna according to claim 1, wherein the antenna has a square or rectangular shape.

4. The rectifying antenna according to claim 1, wherein the conductive graphene portion is disposed above the at least one insulating portion and the metal portion.

5. The rectifying antenna according to claim 1, comprising a reflective layer, covered with an intermediate insulating layer on which the antenna rests, forming a quarter-wave cavity with respect to the electromagnetic radiation to be absorbed.

6. The rectifying antenna according to claim 1, comprising a first connection pad and a second pad configured to bias the diode, wherein the first connection pad is disposed under and in contact with the metal portion, and the second connection pad is disposed under and in contact with the antenna.

7. The rectifying antenna according to claim 1, wherein the at least one insulating portion is made of Al₂O₃, ZrO₂, HfO₂, ZnO, SiO₂, or HfAlO.

8. The rectifying antenna according to claim 1, wherein the at least one insulating portion has a thickness between 0.5 and 4 nm.

9. The rectifying antenna according to claim 1, wherein the diode has dimensions between 20×20 nm and 100×100 nm.

10. The rectifying antenna according to claim 1, comprising an electrical source configured to apply a non-zero bias electrical voltage V_{D} to the diode.

11. The rectifying device according to claim 1, wherein the antenna is configured to absorb infrared or terahertz electromagnetic radiation.

12. An optoelectronic device, comprising an array of rectifying antennas according to claim 1, which are identical to one another.

13. A method for manufacturing a rectifying antenna according to claim 1, comprising the following steps:
making the metal portion of the diode;
making the at least one insulating portion, over and in contact with the metal portion;
producing a graphene layer extending over and in contact with the insulating portion;
localized etching of the graphene layer, thus forming the antenna, the part of which disposed in contact with the at least one insulating portion forms the conductive portion made of graphene.

14. The manufacturing method according to claim 13, comprising the following steps:
making a first and a second connection pad in an intermediate insulating layer;
the metal portion rests on and in contact with the first connection pad and the second connection pad is flush with the intermediate insulating layer;
the graphene layer is made so as to be on and in contact with the at least one insulating portion, and to extend over the intermediate insulating layer into contact with the second connection pad.
